(19) United States
(12) Patent Application Publication
(10) Pub. No.: US 2011/0219321 A1
(43) Pub. Date: Sep. 8, 2011

(54) WEB-BASED CONTROL USING INTEGRATED CONTROL INTERFACE HAVING DYNAMIC HIT ZONES

(75) Inventors: Monica Estela Gonzalez Veron, Seattle, WA (US); Cosmin Catrinescu, Woodinville, WA (US); Patrick Malatack, Seattle, WA (US); Andrew Cuneo, Seattle, WA (US); Benjamin James Worline, Duvall, WA (US); Eric McQuaid Zenz, Seattle, WA (US)

(73) Assignee: Microsoft Corporation, Redmond, WA (US)

(21) Appl. No.: 12/715,604

(22) Filed: Mar. 2, 2010

(51) Int. Cl. G06F 3/048

(52) U.S. Cl. 715/764

(57) ABSTRACT

Embodiments provide integrated control features that can be used to effectively manage and configure data structure information. In an embodiment, a system includes a web-based application that includes an integrated header control interface having a number of dynamic control sections or zones. In one embodiment, a method provides an integrated header control interface that includes dynamic control section that can be used to select, drag and/or drop, resize, sort data, filter data, and/or manage other aspects of a column-based and/or row-based data structure. Other embodiments are included and available.

### BACKGROUND

With the technical progress of providing quality online web application experiences, information management and collaborative computing environments are becoming more and more utilized due in part to additional processing and other available resources. For example, employees can readily interact with data on enterprise servers using web applications. Remote users can use a web application to access a project management application. Web-based applications generally transact data with a server or servers according to individual posting operations to commit data to a server as the user interacts with the application.

Traditional interaction paradigms used in web-based applications are commonly triggered by single click operations followed by a sometimes expensive page refresh. For example, a user can use a menu of a spreadsheet application and database application to iteratively manipulate aspects of a multidimensional column or row. Unfortunately, multiple user iterations and inputs, and/or refresh operations, may be required to produce some user change, such as changing some aspect of a multidimensional column. Such user reiterations are required due in part to inadequate header functionality to provide a quality web-based experience. Traditional headers have limited interactive features and often require the user to navigate away from a current page or selection and may also require one or more potentially costly web calls. Incurring the cost of the use of web calls and refresh operations can be an inefficient and costly process.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide integrated control features that can be used to effectively manage and configure data structure information. In an embodiment, a system includes a web-based application that includes an integrated header control interface having a number of dynamic control sections or zones. In one embodiment, a method provides an integrated header control interface that includes dynamic control sections that can be used to select, drag and/or drop, resize, sort data, filter data, and/or manage other aspects of a column-based and/or row-based data structure. Other embodiments are included and available.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary computing environment.

FIGS. 2A-2O depict aspects of an exemplary web-based application that includes a number of dynamic control headers.

FIG. 3 is a flow diagram depicting an exemplary process of providing a dynamic control interface.

FIG. 4 is a block of an exemplary communication environment.

FIG. 5 is a block diagram illustrating an exemplary computing environment for implementation of various embodiments described herein.

### DETAILED DESCRIPTION

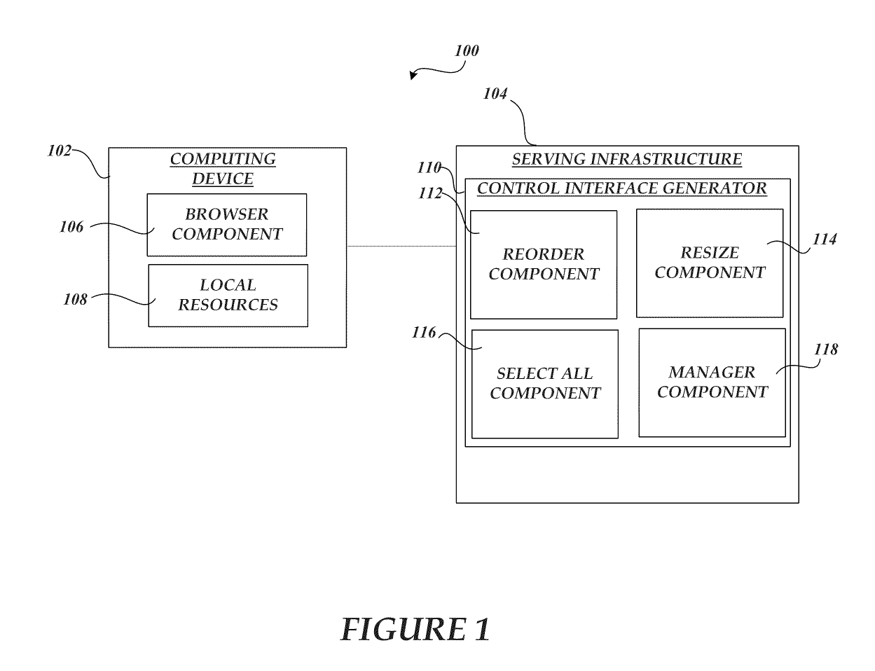

FIG. 1 is a block diagram of an exemplary computing environment 100 that includes a computing device 102 and a serving infrastructure 104, but is not so limited. As discussed below, the serving infrastructure 104 includes functionality to provide web-based application and other services. In an embodiment, the serving infrastructure 104 includes one or more servers and associated components (e.g., processor and memory resources, etc.) that are configured to provide web-based application controls and other features that can be provided to computing device 102 and used to interact with and control aspects of a web-based application.

As shown in FIG. 1, the computing device 102 includes a browser component 106 and local resources 108, such as at least one processor, memory, network interface, local applications, etc., but is not so limited. The browser component 106 can be used to access and use services of the serving infrastructure 104. For example, the browser component 106 can be used to access a web-based information management application, such as MICROSOFT OFFICE LIVE as one example, over some network or combination of networks. As discussed below, components of the serving infrastructure 104 can be used to provide a dynamic integrated control interface, which can be rendered using the browser component 106.

With continuing reference to FIG. 1, the serving infrastructure 104 of an embodiment includes a control interface generator 110 that can be used to provide aspects of the dynamic integrated control interface. In one embodiment, control interface generator 110 can be used to generate a dynamic control interface that is integrated or integral with a header portion of a data structure, such as a column header for example. Aspects of a dynamic integrated control interface can be stored in dedicated storage or memory of the serving infrastructure 104 and/or stored at the computing device 102. In one embodiment, the control interface generator 110 includes a reorder component 112, a resize component 114, a select-all component 116, and a manger component 118, but is not so limited.

The reorder component 112 of an embodiment can be used to receive reorder control inputs associated with user interaction with a provided integrated control interface to reorder or move a portion of a data structure. For example, a user can use a reorder section or portion of a web-based control interface that is integrated into a header to reorder a column of a web-based spreadsheet application, web-based database application, or other columnar data structure.

The resize component 114 of an embodiment can be used to receive resize control inputs associated with user interaction with a provided integrated control interface to resize a portion a data structure. Continuing the preceding example, a user can use a resize section or portion of the web-based control interface that is also integrated into the header to reorder a column of a web-based spreadsheet application, web-based database application, or other columnar data structure.

The select-all component 116 of an embodiment can be used to receive select-all control inputs associated with user interaction with a provided integrated control interface to select all content or all values of a portion of a data structure. Still continuing the preceding example, a user can use a select-all section or portion of the web-based control interface that is also integrated into the header to select all of the content of a column of a web-based spreadsheet application, web-based database application, or other columnar data structure.

The manager component 118 of an embodiment can be used to receive management and configuration control inputs associated with user interaction with a provided integrated control interface to manage and configure a portion of a data structure. Continuing further with the preceding example, a user can use a manage and configure section or portion of the web-based control interface that is also integrated into the header to manage other aspects of a column of a web-based spreadsheet application, web-based database application, or other columnar data structure. In one embodiment, manager component 118 can be used to hide columns, configure columns, sort columns, filter columns, and/or perform other column-based operations, but is not so limited.

In one embodiment, the environment 100 can include web-based and other application functionality including using hypertext markup language (HTML) features, extensible hypertext markup language (XHTML), cascading style sheet (CSS) features, document object model (DOM) features, extensible markup language (XML) features, ECMAScript (e.g., JavaScript, ActionScript, JScript, etc.) and/or other features to provide a web-based integrated header control interface experience. For example, the serving infrastructure 104 can include a number of networked servers that provide various services and/or features (e.g., MICROSOFT PROJECT SERVER features, MICROSOFT SHAREPOINT FOUNDATION features, MICROSOFT SHAREPOINT SERVER features, etc.) used to provide information management functionalities that include providing one or more integrated control features.

While a certain number and types of components are described above, it will be appreciated that other numbers and types can be included according to various embodiments. Accordingly, component functionality can be further divided and/or combined with other component functionalities according to desired implementations. For example, combined resources of one or more server components and one or more client components can be used to provide certain header control features.

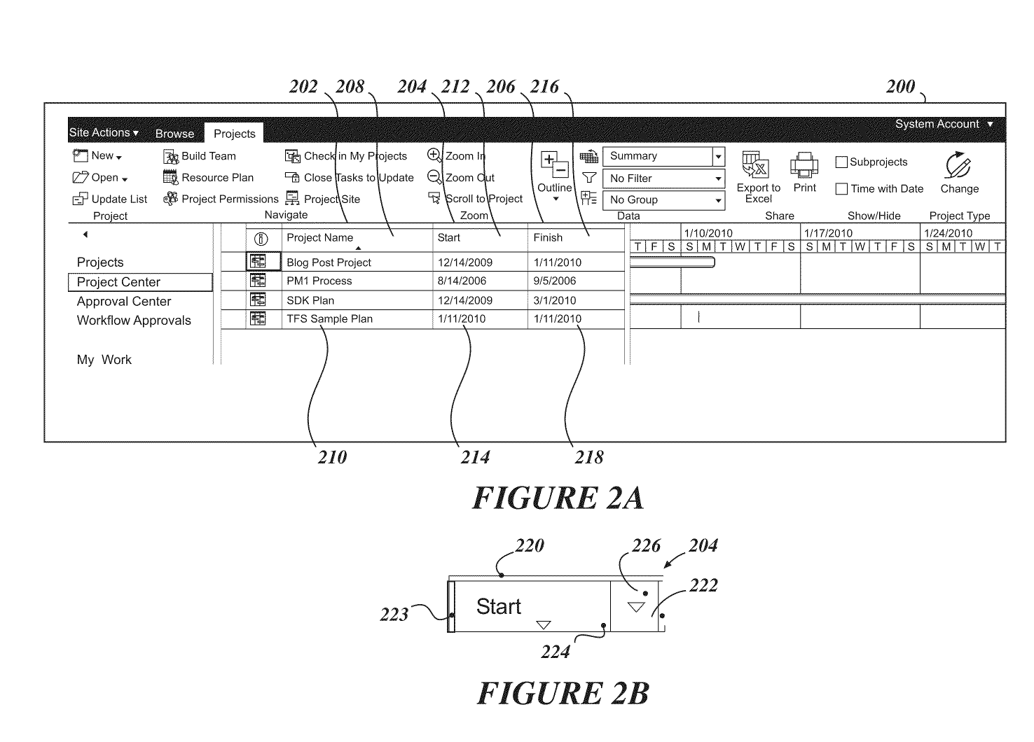

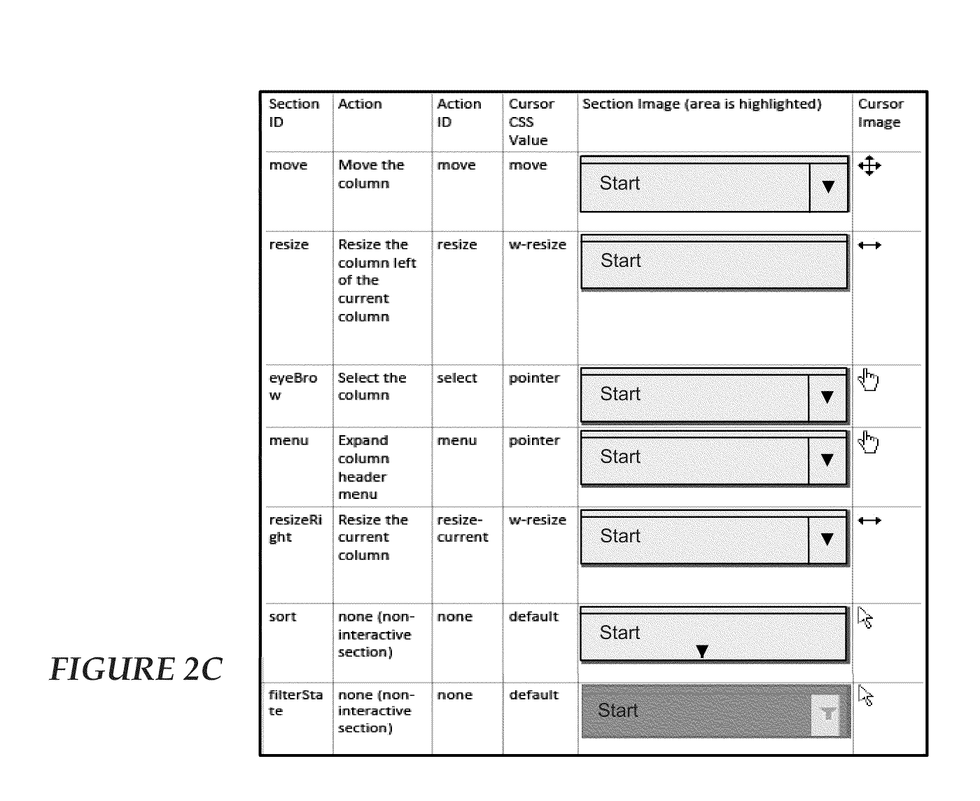

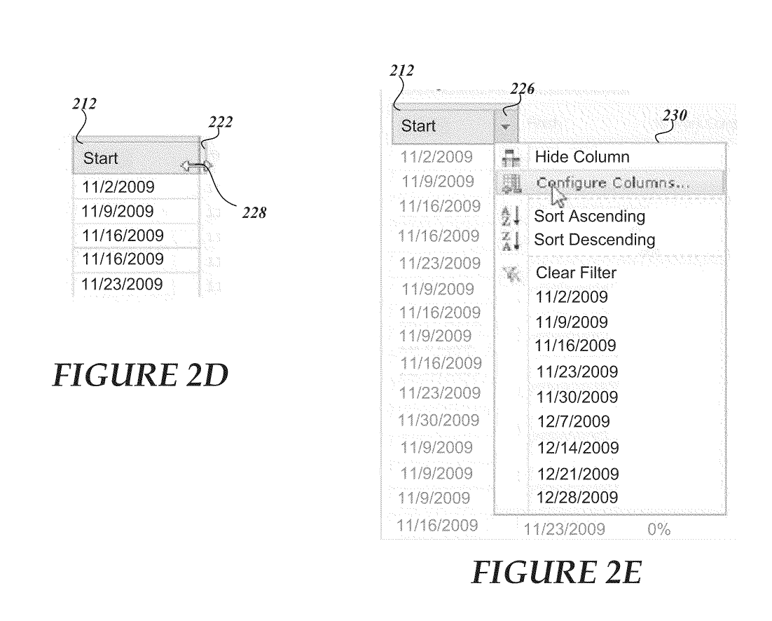

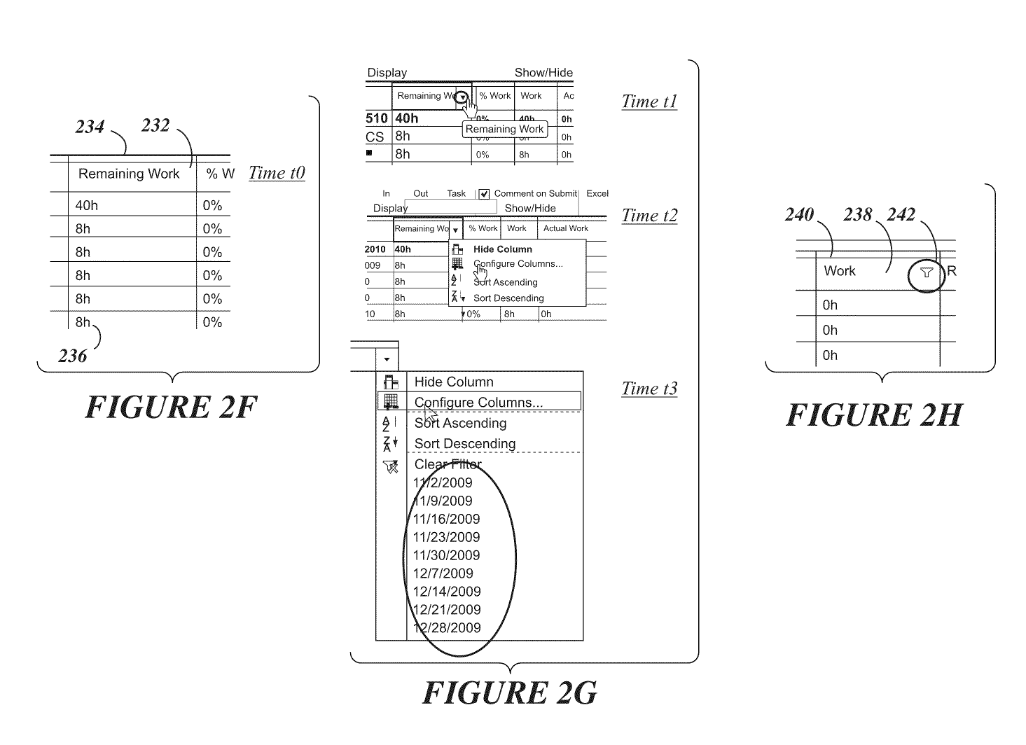

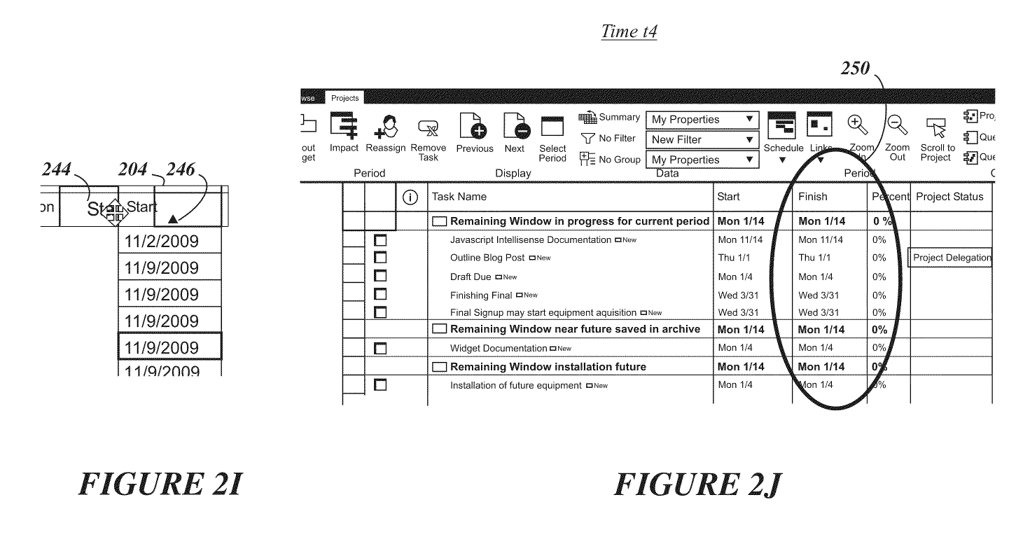

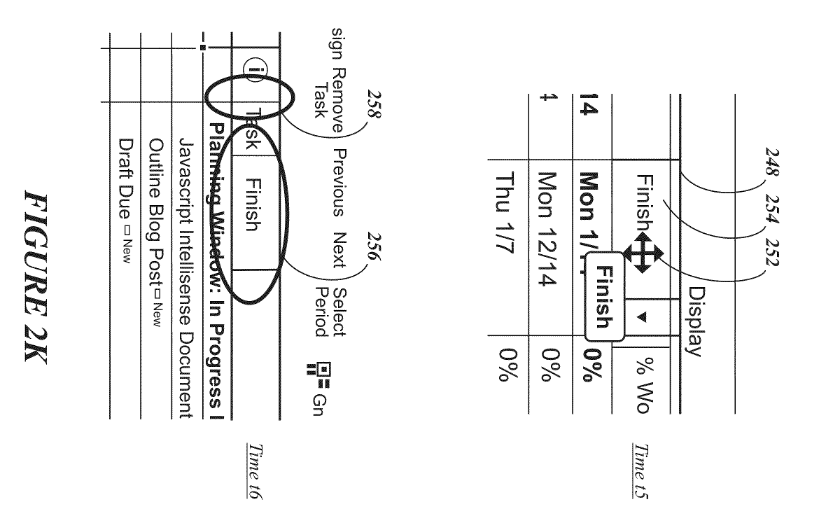

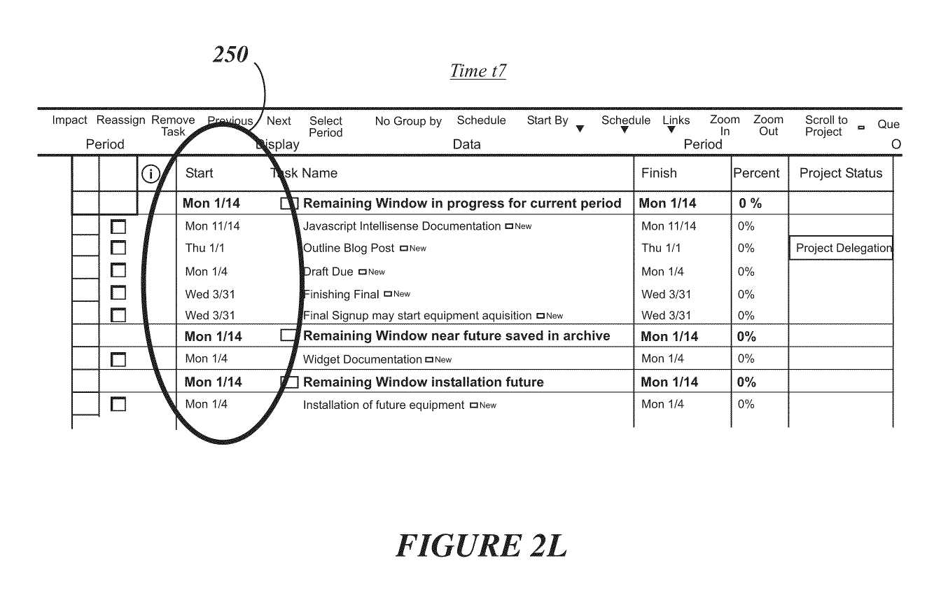

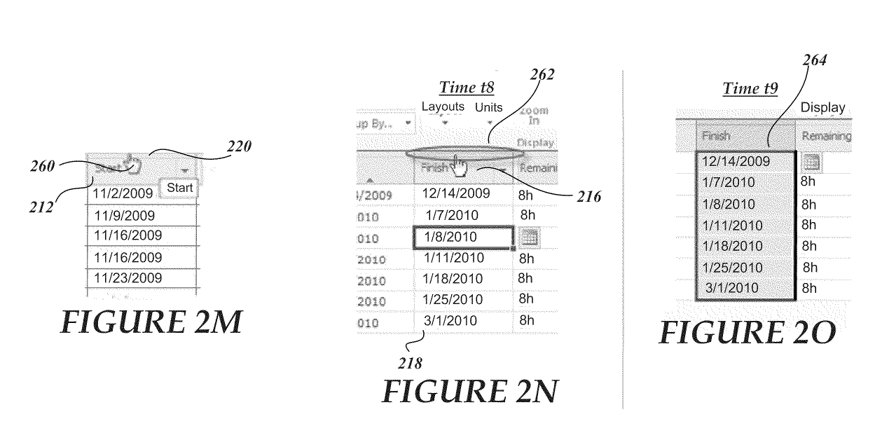

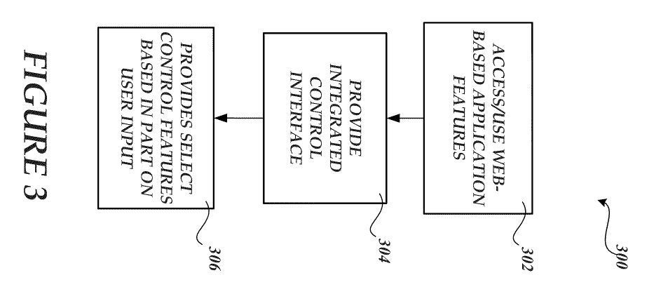

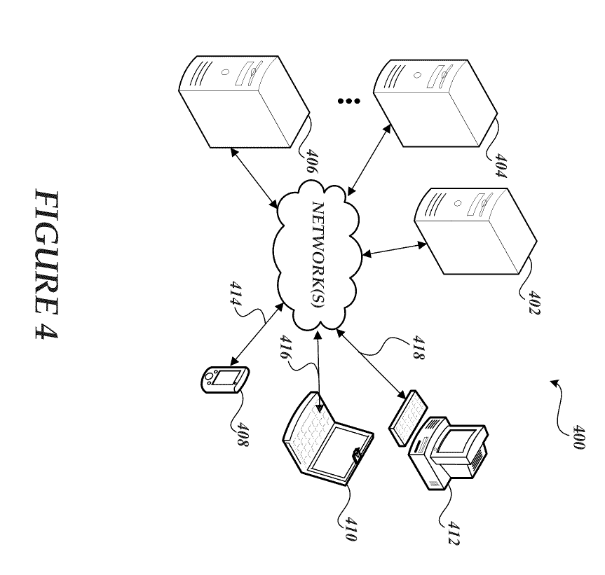

FIGS. 2A-2O depict aspects of an exemplary web-based application 200 that includes a number of control headers 202-206. The control headers 202-206 can be provided for real-time management and manipulation of complex data sets while seamlessly staying in the same context without or absent requiring a refresh operation. As discussed below, the control headers 202-206 of an embodiment include dynamic hit zones that appear and disappear as they become relevant. For example, one or more of the control headers 202-206 can be used to resize, reorder, sort, select and/or hide columns as part of providing integrated control features and functionality for interacting with the web-based application 200.

In an embodiment, components of a processor-based serving system can be used to dynamically provide control features of each control header based in part on user input received from a client computing device or system. In another embodiment, components of a processor-based serving system can be used in conjunction with components of a client computing device to dynamically provide control features of each control header. As shown in the example web-based application 200 of FIG. 2A, control header 202 includes a dynamic control interface 208 associated with a first column of information 210, control header 204 includes a dynamic control interface 212 associated with a second column 214 of information, and control header 206 includes a dynamic control interface 216 associated with a third column 210 of information 218, but is not so limited.

FIG. 2B depicts aspects of exemplary control header 204. In one embodiment, the control header 204 can be provided to include a number of integrated control portions or sections 220-226, but is not so limited. As discussed below, one or more of the control sections 220-226 of control header 204 can be dynamically generated and displayed based in part on a web-based application control input (e.g., a hover operation or other input operation).

In one embodiment, control section 220 operates to select all content of column 214, control sections 222 and 223 operate to resize column 214, control section 224 operates to relocate column 214, and/or control section 226 operates to manage and/or configure other aspects of column 214. It will be appreciated that a client and one or more servers can be used to provide control section functionality. For example, use (e.g., tap, click, etc.) of control section 220, control section 222, and/or control section 224 can be performed without or absent requiring web-service calls to support each associated feature. In an alternative embodiment, activation of control section 226 includes a web-service call operation to populate parameters of filter controls.

In one embodiment, each control header can be is represented using an HTML TH element. The TH element can be tagged with metadata including a key of a grid column represented by the TH element. The TH element contains a number of DIV elements, wherein each DIV element can correspond to a control section of a header control interface. Each section can include custom properties that provide metadata about which action (if any) the section enables, allowing for quick access to the corresponding DOM element. Correspondingly, event handling and rendering are bound together to thereby make the task of only enabling certain actions on a given column header interface and managing interactions with the column header interface straightforward (e.g., hover, one-click, etc.) and robust.

For example, the following HTML can be used to generate a control header for “Project Name” columns when a corresponding column is “active”. Correspondingly, the example HTML can be used to provide a control header having a dynamic control interface based in part on control inputs from an input device or user interface (e.g., mouse or finger used to hover a cursor display over a column or control header) as follows:

```
  <DIV style=“BORDER-BOTTOM: #c8ccd0 1px solid; BACKGROUND-
COLOR: #dfe3e8; WIDTH: 99px” class=jsgrid-header-eyebrow colAction=“select”
colid=“eyeBrow”>
  </DIV>
  <DIV style=“BACKGROUND-COLOR: #dfe3e8; FLOAT: left; CURSOR: w-
resize; BORDER-RIGHT: #dfe3e8 1px solid” class=jsgrid-header-expand colAction=“resize”
colid=“resize”>
  </DIV>
  <DIV style=“TEXT-ALIGN: left; LINE-HEIGHT: 19px; PADDING-LEFT: 2px;
WIDTH: 73px; HEIGHT: 19px; COLOR: #363636; FONT-SIZE: 1em; CURSOR: move;
FONT-WEIGHT: normal” class=jsgrid-header-core-content colid=“coreContent”>
  Project Name
  </DIV>
  <IMG class=jsgridcluster_jsgrid-up-arrow title=“Sorted Ascending” alt=“Sorted
Ascending” src=“/_layouts/Images/jsgridcluster.png” colid=“sortImg”>
  <DIV style=“LEFT: 42px” class=clip9x6 colid=“sort”>
  </DIV>
  <DIV style=“BACKGROUND-COLOR: #dfe3e8; WIDTH: 75px; FLOAT: left”
class=jsgrid-header-content colid=“content”>
  </DIV>
  <IMG class=jsgridcluster_jsgrid-down-arrow title=“Open Menu” alt=“Open
Menu” src=“/_layouts/Images/jsgridcluster.png”>
  <DIV style=“MARGIN-TOP: 10px” class=clip9x6 colid=“menuImg”>
  </DIV>
  <DIV style=“PADDING-LEFT: 4px”>
  </DIV>
  <DIV style=“BORDER-LEFT: #ffd359 1px solid; BACKGROUND-COLOR:
#ffeb91; WIDTH: 14px; DISPLAY: block; FLOAT: left” class=jsgrid-header-menu
colAction=“menu” colid=“menu”>
  </DIV>
  <IMG class=jsgridcluster_jsgrid-header-filter-icon title=“This column has a filter
applied” src=“/_layouts/Images/jsgridcluster.png”>
  <DIV style=“MARGIN-TOP: 7px” class=clip11x11 colid=“filterStateImg”>
  </DIV>
  <DIV style=“PADDING-LEFT: 3px”>
  </DIV>
  <DIV style=“BORDER-LEFT: transparent 1px solid; WIDTH: 14px; FLOAT:
left” class=jsgrid-header-filter-state colid=“filterState”>
  </DIV>
  <DIV style=“BACKGROUND-COLOR: #ffeb91; FLOAT: left; CURSOR: w-
resize” class=jsgrid-header-expand colAction=“resize-current” colid=“resizeRight”>
  </DIV>
  <DIV style=“BORDER-BOTTOM: #b1b5ba 1px solid; POSITION: relative;
BACKGROUND-COLOR: #dfe3e8; WIDTH: 99px; HEIGHT: 26px” colAction=“move”
colid=“move”>
  </DIV>
  <TH style=“BACKGROUND-COLOR: #dfe3e8; WIDTH: 99px; BORDER-
RIGHT: #b1b5ba 1px solid” title=“Project Name” role=columnheader scope=col
headerStyleType=“0” headerStyleBorderString=“1px solid #B1B5BA”
thColumnKey=“PROJ_NAME”>
  </TH>
```

As shown for the exemplary control header 204 of FIG. 2B, integrated control section 220 can be graphically presented as a horizontally disposed header control portion (e.g., a strip or eyebrow) that corresponds to a distinct control portion of the control header 204, integrated control section 222 can be graphically presented as a vertically disposed header control portion that corresponds to another distinct control portion of the control header 204, integrated control section 224 can be graphically presented as another horizontally disposed header control portion that corresponds to another distinct control portion of the control header 204, and/or integrated control section 226 can be graphically presented as yet another distinct control portion of the control header 204. In one embodiment, the integrated control section 226 is concealed within control header 204 and dynamically exposed upon receiving a control input, such as an extended hover action, right click, or some other activating action.

FIG. 2C is a table that illustrating aspects of exemplary header control features that include a number of section controls and corresponding metadata that defines an associated action. As shown in FIG. 2C, the table includes a Section ID column, an action column, an Action ID column, and a cursor CSS value column, a Section Image column, and a cursor image column. The exemplary parameters of the table define each section and associated features. The Section ID parameters of one embodiment identify integrated control sections of a control header interface: move, resize, eyebrow, menu, resize right, sort, and/or filter state.

The Section Image and Cursor image columns depict a number of exemplary header and cursor display states for a corresponding section and/or action. For example, section and cursor images can be provided based in part on a hover operation over a corresponding header control and/or column. Tool tips can be provided after a user has hovered over a control portion for some defined period of time.

In an embodiment, an integrated header control interface includes dynamic control sections including: a move control section that operates to move a select column from a first columnar position to a different columnar position; a resize control section that operates to resize an adjacent column to the left of a select column; an eyebrow control section that operates to select all content associated with a select column; a menu control section operates to expand a column header menu of a select column; a resize right control section that operates to resize a select column; a sort section that operates to identify a sort direction or order; and a filter state section that operates to identify a filter application or operation.

As shown in FIG. 2C, the Section Image column includes images that identify features of each section. As shown, the move control section is highlighted to depict that it exists in the background, behind the resize and menu control sections. In an embodiment, interaction with a move control section operates to generate a shadow copy of the header and/or column for displaying adjacently to a select column (see FIG. 2J). The shadow copy can be displayed as a semi-transparent image of the header control and/or column portion to identify that the select column is under reorder control.

Control input to the highlighted resize control section causes the header to the left of the select column header to be highlighted, identifying that the adjacent column will be resized using the resize control section. Control input to the highlighted eyebrow section selects an entire column. Control input to the highlighted menu control section operates to expand a column header menu that includes further options, such as filter, sort, and other columnar and/or data management operations.

Control input to the highlighted resize right control section causes the column to be resized to the right and highlights an adjacent header's resize right control section. The highlighted sort section identifies that a particular column has been sorted including the sort direction or order. The sort section can be hidden if no filter is applied. In one embodiment, a sort icon of a sort section can be toggled to change a sort order. The highlighted filter state section indicates that a filter or filter operation has been applied for a particular column. The filter state section can be hidden if no filter is applied. In one embodiment, each control section can be dynamically displayed based on where an input device is located with respect to a particular column and/or header control.

FIG. 2D depicts a portion of a column of data and control header 204 as a user hovers over control section 222 of dynamic control interface 212. As shown, exemplary resize cursor image 228 is dynamically displayed with control section 222 as part of providing a dynamic resize control interface.

FIG. 2E depicts control header 204 as a user selects (e.g., click, tap, etc.) control section 226 which expands drop down menu 230. As shown, the exemplary features of drop down menu 230 include a hide column feature, a configure columns feature, ascending and descending sort features, and filter features that depict filter parameter examples. In one embodiment, activation of control section 226 results in a web call to populate filter parameters and/or filter types.

FIGS. 2F-2H depict a time sequence of events associated with the use of a dynamic control header 232 to manage and configure aspects of an exemplary column 234 that includes data values 236. FIG. 2F shows the column 234 and dynamic control header 232 absent user interaction at time t0. FIG. 2G depicts use of control header 232 at times t1-t3. At time t2, filter parameters are populating. At time t3, the filter parameters have been populated for use. FIG. 2H depicts another dynamic control header 238 of a different column 240. As shown, a filter icon 242 (lassoed with lead line) is displayed to inform a user that a filter has been applied to the column 240.

FIG. 2I depicts control header 204 as a user selects control section 224 (e.g., click and hold, tap and hold, etc.). As shown, a ghost or shadow header copy 244 is dynamically displayed to inform a user of a potential columnar position for the column. FIG. 2I also depicts sort indicator 246 identifying a sorting direction for the column.

FIGS. 2J-2K depict a time sequence of events associated with the use of a dynamic control header 248 to relocate exemplary column 250. FIG. 2J shows the column 250 and dynamic control header 248 absent user interaction at time t4. FIG. 2K depicts use of control header 248 to move column 250 from a first columnar position associated with time t4 to a second columnar position associated with time t7. At time t5, cursor 252 transitioned to the cross indicator as a user hovers over a move control section 254 of control header 248. At time t6, a shadow image 256 (shown lassoed with lead line) is generated and displayed as the user moves the column 250 to the second columnar location, wherein target boundary 258 (shown lassoed with lead line) delineates a designated location for the column. FIG. 2L shows the column 250 as relocated to the second columnar position at time t7.

FIG. 2M depicts a portion of the column of data and control header 204 as a user hovers over control section 220 of dynamic control interface 212. As shown, exemplary cursor image 260 is dynamically displayed with control section 220 as part of providing a select all control.

FIGS. 2N-2O depict a time sequence of events associated with the use of dynamic control header 206 to select all content associated with column 218. FIG. 2N shows time t8 where the cursor has transitioned to indicate a select all operation as a user hovers over control section 262 of dynamic control interface 216. FIG. 2O shows the column 218 at time t9 including a generated outline 264 surrounding the selected cells and informing a user of the selected content as an operation result.

In one embodiment, a TH element can be used in part to provide control header features as part of a web-based application environment accessed using a web browser or component. For example, a TH element can be built using javascript as follows:

```
  function PopulateTh(th, columnKey, bIsSorted, bIsFiltered )
  {
  var html = [‘<div colid=“eyeBrow” class=“jsgrid-header-eyebrow”
colAction=“select” style=“border-bottom:1px solid transparent;”></div>’,
  ‘<div colid=“move” colAction=“move” style=“position:relative;”>’];
  // enabling or disabling will be set later
  html.push(‘<div colid=“resize” colAction=“resize” class=“jsgrid-header-expand”
style=“float:left;”></div>’);
  html.push(‘<div colid=“content” class=“jsgrid-header-content”
style=“float:left;”><div colid=“coreContent” class=“jsgrid-header-core-content”
style=“cursor:move;”></div>’);
  html.push(‘<div colid=“sort” class=“clip9x6” style=“display:’ + (bIsSorted ? ” :
‘none’) + ‘><img colid=“sortImg” class=“jsgridcluster_jsgrid-down-arrow”
src=“/_layouts/Images/jsgridcluster.png”/></div>’);
  html.push(‘</div>’);
  html.push(‘<div colid=“menu” class=“jsgrid-header-menu” colAction=“menu”
style=“flot:left;width:14px;border-left:1px solid transparent;”><div style=“padding-
left’:4px;”><div colid=“menuImg” class=“clip9x6” ><img class=“jsgridcluster_jsgrid-
down-arrow” src=“/_layouts/Images/jsgridcluster.png” alt=“Open Menu” title=“Open
Menu”/></div></div></div>’);
  html.push(‘<div colid=“filterState” class=“jsgrid-header-filter-state”
style=“float:left;width:14px;border-left:1px solid transparent;display:’ + (bIsFiltered ? ” :
‘none’) + ”‘><div style=“padding-left:3px;”><div colid=“filterStateImg” class=“clip11x11”
><img class=“jsgridcluster_jsgrid-header-filter-icon”
src=“/_layouts/Images/jsgridcluster.png” title=“This column has a filter
applied”/></div></div></div>’);
  html.push(‘<div colid=“resizeRight” class=“jsgrid-header-expand”
colAction=“resize-current” style=“float:left;cursor:w-resize;”></div>’);
  html.push(‘</div>’);
  th.innerHTML = html.join(″);
  th.thColumnKey = columnKey;
  }
```

When a user interacts with an integrated header interface (e.g., move/click operations, etc.), a target element of the interaction or action is provided by the browser component. The target element can be used as an input to a number of interaction handling functions (see actions of FIG. 2C for example). For a given target element, the following code can be used to update a color of the appropriate section. The function FindAncestorWithProperty can be used to traverse the HTML DOM, looking through the passed element's ancestors for one tagged with the property specified. If no such element is found, it returns null, otherwise it returns the element with the property. The UpdateColor function sets the correct color on the specified element. Note that the property ‘colid’ corresponds to the value of the ‘Section Id’ column in the table above.

function UpdateColorFromMouseMove(targetDOMElement)
{
var th = FindAncestorWithProperty(targetDOMElement, ‘thColumnKey’);
if (th != null)
{
var elem = FindAncestorWithProperty(targetDOMElement, ‘colid’);
if (elem != null)
{
UpdateColor(th.thColumnKey, elem);
}
}
}

Given the target element, the following code can be used to determine the column header action the user intended by a click/tap operation. In one embodiment, the InitiateAction function contains the detailed implementation of each action. For example, in the case of a resize control section, the control feature includes setting state and updating the width of the given column on future input (e.g., mouse moves) until a user releases focus (e.g., mouse up). Note that property “co1Action” of one embodiment corresponds to a value of the Action ID column of FIG. 2C.

```
  function FindActionFromMouseDown(targetDOMElement)
  {
  var th = FindAncestorWithProperty(targetDOMElement, ‘thColumnKey’);
  if (th != null)
  {
  var elem = FindAncestorWithProperty(targetDOMElement, ‘colAction’);
  if (elem != null)
  {
  InitiateAction(th.thColumnKey, elem.colAction)
  }
  }
  }
  In one embodiment, an integrated header control interface uses control inputs
(e.g., hover detections) as part of determining whether to display a column menu dropdown
arrow, as follows:
  // returns true if the column menu arrow should be drawn in the header
  this.CanExpandMenu = function(column, bHidableColumns, bSortableColumns,
bAutoFilterableColumns, bResizableColumns)
  {
  return (bHidableColumns ∥
  bResizableColumns ∥
  (bSortableColumns  &&
delegateMgr.DelegatePresent(SP.JsGrid.DelegateType.Sort)) ∥
  (bAutoFilterableColumns && column.isAutoFilterable &&
  delegateMgr.DelegatePresent(SP.JsGrid.DelegateType.GetAutoFilterEntries) &&
  delegateMgr.DelegatePresent(SP.JsGrid.DelegateType.AutoFilter) &&
  delegateMgr.DelegatePresent(SP.JsGrid.DelegateType.LaunchFilterDialog)) ∥
  (column.columnKey == SP.JsGrid.RecordIndicatorCheckboxColumnKey) ∥
  (delegateMgr.DelegatePresent(SP.JsGrid.DelegateType.WillAddColumnMenuIte
ms) &&
  delegateMgr.Apply(SP.JsGrid.DelegateType.WillAddColumnMenuItems,
columnKey)));
  }
```

As one example, if a user continues hovering over a column header, the column header can determine whether to display a dropdown arrow as part of providing a dynamic control section using a CanExpandMenu result.

FIG. 3 is a flow diagram illustrating an exemplary process 300 of providing a dynamic control interface. In an embodiment, the process 300 can be used to provide features of an integrated header control interface. The integrated header control interface of one embodiment includes a number of dynamic hit zones or sections that appear and disappear as they become relevant based in part on a user control input. For example, the process 300 can provide control headers that include dynamic hit zones that can be used to resize, reorder, sort, select, hide and perform other columnar manipulation operations using an integrated header control interface.

At 302, a user uses a web computing interface to access and use features of a web-based application. For example, a user can use a browser to access an information management system to work on aspects of an ongoing project. At 304, an integrated control interface is provided as part of providing user interaction features of the web-based application. In an embodiment, the process 300 at 304 includes using a server component to process client requests including providing control headers having integrated control features for each column of an information management file. The integrated control features can be dynamically presented and used to provide a rich interaction experience while using a web-based application.

At 306, the process 300 provides select control features based in part on interactive inputs to the integrated control interface. In an embodiment, the process at 304 provides an integrated header control interface that includes integrated header control features that respond to user inputs including: sort features including a sort indicator for a sorted column, filter features including a filter indicator for a filtered column, context menu option features, resize features, select column features, move or reorder column features, column definition features, and/or other header control features. While a certain number and order of operations is described for the exemplary flow of FIG. 3, it will be appreciated that other numbers and orders can be used according to desired implementations.

FIG. 4 is a block diagram of an exemplary communication environment 400. In an embodiment, components of the communication environment 400 operate to provide communication functionality and features to users of the environment 400. As shown, the exemplary communication environment 400 includes a networked association of computing devices/systems and associated communication infrastructure. The environment 400 may include multiple communication networks, server components (e.g., project server 402, collaboration server 404, file server 406, etc.), and/or client devices/systems having various communication functionalities (e.g., smart phone 408, laptop 410, desktop 412, etc.).

As shown by the example of FIG. 4, the smart phone 408 is coupled to the network via communication path 414, laptop 410 is coupled to the network via communication path 416, and the desktop 412 is coupled to the network via communication path 418. It will be appreciated that each path can include a number of communication links, pathways, and/or other components that contribute to providing communication and other functionality to end-users. Exemplary communication environments can include the use of secure networks, unsecure networks, hybrid networks, and/or some other network or combination of networks. By way of example, and not limitation, the environment 100 can include wired media such as a wired network or direct-wired connection, and/or wireless media such as acoustic, radio frequency (RF), infrared, and/or other wired and/or wireless media and components.

In various embodiments components of at least one client computer operate in conjunction with one or more server components to provide header controls that include integrated header control interfaces. For example, a dedicated server can be used to provide integrated header control features to a client after accessing a web-based application. In one embodiment, once accessed, header control parameters can be stored locally and/or remotely.

In addition to computing systems, devices, etc., various embodiments can be implemented as a computer process (e.g., a method), an article of manufacture, such as a computer program product or computer readable media, computer readable storage medium, and/or as part of various communication architectures. An exemplary computer program product can include computer storage media that includes useable control and/or communication instructions.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components include, but are not limited to, wide area networks (WANs), local area networks (LANs), metropolitan area networks (MANs), proprietary networks, backend networks, etc.

Client computing devices/systems and servers can be any type and/or combination of processor-based devices or systems. Additionally, server functionality can include many components and include other servers. Components of the computing environments described in the singular tense may include multiple instances of such components. While certain embodiments include software implementations, they are not so limited and encompass hardware, or mixed hardware/software solutions. Other embodiments and configurations are available.

### Exemplary Operating Environment

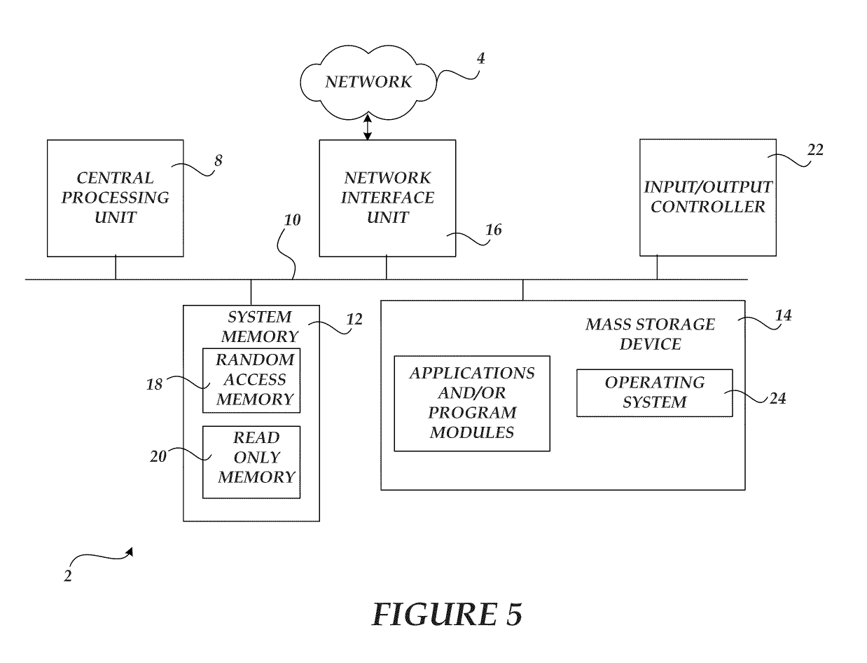

Referring now to FIG. 5, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 5, an illustrative operating environment for embodiments of the invention will be described. As shown in FIG. 5, computer 2 comprises a general purpose desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method comprising:
receiving a request to use web-based application services;
providing an integrated control interface in responding to the request, the integrated control interface having a number of integrated control zones including:
a reorder control zone to receive reorder control inputs as part of reordering a data structure of information;
a resize control zone to receive resize control inputs as part of resizing the data structure of information;
a select control zone to receive select control inputs as part of selecting all content of the data structure of information; and
a manage and configure control zone to receive management and configuration control inputs as part of managing and configuring aspects of the data structure of information; and
storing the data structure and parameters of the integrated control interface.

2. The method of claim 1, further comprising dynamically displaying the control zones using a browser interface, wherein the integrated control interface includes a header control associated with a columnar data structure.

3. The method of claim 2, further comprising detecting a hover operation as part of dynamically displaying header control features of the integrated control interface.

4. The method of claim 1, further comprising providing an interactive eyebrow region with the integrated control interface of a column header, the eyebrow enabling selection of all cell content of an associated column.

5. The method of claim 1, further comprising generating draggable borders on a side portion of a column header allowing resizing of an associated column.

6. The method of claim 1, further comprising generating a dropdown control as part of receiving a control input to the manage and configure control zone, the dropdown control allowing access to contextual functions for manipulating data and metadata of an associated column.

7. The method of claim 1, further comprising providing a sort control on an integrated control header interface allowing at a glance sort determination.

8. The method of claim 7, further comprising providing a filter control on the integrated control header interface allowing at a glance filter determination.

9. The method of claim 1, further comprising providing a draggable region with the reorder control zone as part of responding to the reorder control inputs and allowing drag and drop and columnar reorder operations.

10. The method of claim 9, further comprising generating and displaying a shadow copy of a selected column header as part of responding to the reorder control inputs.

11. The method of claim 1, further comprising providing aspects of the integrated control interface absent requiring a refresh operation.

12. The method of claim 1, further comprising binding event handling operations with rendering operations to provide defined actions of the integrated control interface.

13. A system comprising:
at least one processor;
a dynamic header control interface coupled to the at least one processor to provide interactive control features to interact with a column of information, the interface including:
a move control to move the column of information;
a resize control to resize the column of information;
a select control to select all values of the column of information;
a sort component to identify sort operations; and
a filter component to identify filter operations; and
memory to store parameters of the dynamic header control interface.

14. The system of claim 13, the move control further operable to generate a shadow copy of a portion of a selected column.

15. The system of claim 14, the move component further operable to generate a semi-transparent image for the shadow copy to identify a moving column.

16. The system of claim 13, the dynamic header control interface further comprising a column header including an element tagged with metadata and a key of an object corresponding to the element.

17. The system of claim 16, the element containing a number of sub-elements which correspond to a header control section, the header control section including custom properties having metadata that defines an action enabled by the header control section.

18. A computerized user interface comprising:
a web-based information management application; and,
an integrated header control for interacting with the web-based information management application including:
a reorder component operable to reorder an associated column;
a resize component to resize the associated column;
a select component to select content of the associated column; and
a management control to manage other aspects of the associated column.

19. The interface of claim 18 to operate with a browser component to dynamically provide dynamic control features using a computer network.

20. The interface of claim 18, the integrated header control further comprising displayable sort and filter identifiers to identify sort and filter operations.
